(19) United States
(12) Patent Application Publication
(10) Pub. No.: US 2016/0110148 A1
(43) Pub. Date: Apr. 21, 2016

(54) MOTOR VEHICLE INFOTAINMENT SYSTEM HAVING A SEPARATE DISPLAY UNIT

(71) Applicant: AUDI AG, Ingolstadt (DE)

(72) Inventors: FRANK EGLE, KÖSCHING (DE); MICHAEL SCHMAILZL, KÖSCHING (DE); MATHIAS HALLIGER, KIPFENBERG (DE); ROBERT WITTMANN, GEISENFELD (DE)

(73) Assignee: AUDI AG, 85045 INGOLSTADT (DE)

(21) Appl. No.: 14/894,820

(22) PCT Filed: Jun. 2, 2014
(86) PCT No.: PCT/EP2014/001479

§ 371 Date: Nov. 30, 2015

(30) Foreign Application Priority Data
Jun. 7, 2013 (DE) 10 2013 009 580.8

(51) Int. Cl. G06F 3/147; G06F 3/14; G06F 1/16; B60R 11/02; G06F 3/041

(52) U.S. Cl. CPC G06F 3/147; B60R 11/0229; G06F 3/0412; G06F 3/0416; G06F 1/1654; G06F 1/1635; G06F 1/1698; G06F 3/1423; B60R 2011/0049

(57) ABSTRACT

A motor vehicle has an infotainment system with a controller for providing infotainment functions and a display unit, which is structurally separate from the controller and which has a screen for displaying display data. The display unit is retained in a motor-vehicle interior by a retaining device. The display unit allows a suitable posture when viewing different infotainment functions on the display unit by making the retaining device and the display unit nondestructively and reversibly detachable from each other. The controller is designed to transfer the display data to the display unit even while the display unit is detached from the retaining device.

The invention relates to a motor vehicle with an infotainment system. The infotainment system includes a controller for providing infotainment functions and a display unit structurally separate from the controller and having a screen for displaying display data. The display unit is held in a motor vehicle interior of the motor vehicle by a retaining device. For example, the display unit to be held, for example, by the retaining device on a switch panel, a center console or in the rear of the motor vehicle for example to a seat back.

An infotainment system can be used to perform a variety of infotainment features, such as navigation, media playback (TV or Blu-ray), telephony, operating the air conditioning system, adjusting the seat position or also configuring the driving behavior of the motor vehicle (acceleration response, damper settings). As a user interface, an infotainment system may include for this purpose a display unit with a screen on which display data can be displayed to a user. Display data in the context of the invention refer to information data, such as current parameter values of motor vehicle parameters, operating menus, video data of video streams, such as movies, or display data for displaying user interfaces with control elements, such as buttons and sliders.

The display unit with its screen must be placed in the motor vehicle such that the user can view the screen without having to physically contort or getting tired due to reflections or an awkward posture during prolonged viewing. Under no circumstances must the user be forced to abandon a safe seating position in the motor vehicle in order to look at the screen while driving.

The problem exist here that different seat positions and head positions are favorable for the variety of infotainment functions provided by the infotainment system. For this purpose, it is known to provide one or more screens on the backs of the backrests of the driver and the front passenger seat for displaying video data for passengers in the rear of the motor vehicle (e.g. persons on the rear bench seat). The passengers in the rear then do not have to lean forward to look at a screen, for example, in the instrument panel. One or more additional screens are also provided in the instrument panel and/or the center console for the driver and the passenger.

It is also known in the prior, art to allow a passenger to connect to the infotainment system of the motor vehicle his laptop, notebook or mobile phone in order to supply the mobile device, for example, with electricity, or to use an Internet connection of the motor vehicle also for the mobile device.

It is known from DE 10 2007 046 130 A1 to provide in the rear of a motor vehicle a multimedia connection with a power supply and a data communications port. For example, this connection can be arranged in a headliner of the motor vehicle and have the form of a cable with connectors that can be connected to a laptop.

A vehicle with multimedia components, such as a motor vehicle infotainment module and an on-board telephone is also known from WO 2006/072585 A1. These devices can be connected via a connector provided in the vehicle with a notebook or mobile phone of a user and hence can also be used by these mobile devices.

DE 10 2007 027 231 A1 describes a device arrangement for a motor vehicle that is designed for operating and controlling a mobile terminal in the motor vehicle. The arrangement can be used to operate a mobile navigation device brought into the vehicle by way of a controller that is permanently installed in the vehicle.

It is an object of the invention to provide in a motor vehicle a display unit for an infotainment system, wherein the display unit allows an appropriate posture when viewing the display unit while using different infotainment functions of the infotainment system.

The object is achieved by a motor vehicle according to claim 1 and a display unit according to claim 15. Advantageous developments of the invention are recited in the dependent claims.

The invention is based on the situation known in the prior art that an infotainment system is provided in a motor vehicle which has, for providing the infotainment functions, a controller and as a user interface a display unit that is structurally separate from the controller. Other terms for user interface are man-machine interface and Graphical User Interface (GUI). The display unit has for this purpose a conventional screen for displaying display data, e.g. video data of a movie or graphic data of an operating menu of the infotainment system. These display data are provided by the controller and transmitted to the display unit.

The display unit is held in the motor vehicle's interior by a retaining device of the motor vehicle. Accordingly, for example, the display unit with its screen may be attached in a frame in the instrument panel of the motor vehicle, or in the rear section on a rear side of a front seat of the motor vehicle.

In the motor vehicle according to the invention, the display unit can also be removed from the retaining device. The retaining device and the display unit are for this purpose constructed so as to be reversibly detachable from each other without being destroyed. The display unit may be held, for example, on the retaining device by a snap connection or can be placed on the retaining device by a locking mechanism or also by way of a rail. A user can thus remove the display unit from the retaining device and place the display unit, for example, on his lap. The controller is designed to transmit the display data to the display unit even when the display unit is detached from the retaining device. The display data are thus also displayed to the user by the display unit when the user has detached the display unit from the retaining device and has, for example, placed the display unit in his lap. A user can then advantageously move the display unit in the motor vehicle independent of the retaining device while operating the infotainment system, and arrange the display unit in a favorable position and orientation for viewing the screen.

In an advantageous embodiment of the motor vehicle according to the invention, at least one control element of the user interface of the infotainment system is integrated in the display unit. For example, at least one control button or rotary knob or slider can be integrated in the removable display unit. The display unit is also configured to transmit control data to the controller in response to an operation of the at least one operating element, for example when an operating button is pressed. Advantageously, configuration data in the infotainment system, for example a seating position of a reclining seat or a navigation destination of a navigation application of the infotainment system, can be adjusted by way of the display unit. The corresponding infotainment function is thus configured by the controller in dependence on the received control data.

The screen in the motor vehicle according to the invention is preferably designed as a touch screen. An aforementioned operating element of the user interface can then be provided by the touch-sensitive surface of the screen. The display unit then does not require any additional mechanical actuating or switching elements, which reduces its production costs.

Preferably, data, for example the display data and optionally the control data are exchanged between the controller and the display unit via a radio link. In a further development, the controller and the display unit in the motor vehicle have each a respective radio module and are designed to exchange data with each other via the radio link of their radio modules. A WLAN connection (WLAN—Wireless Local Area Network) and/or a Bluetooth connection are preferably provided by the radio modules as a radio link. Exchanging the data via radio has the advantage that the display unit also does not have to be connected with the controller via a data cable. In addition, the amount of image data of the display data may advantageously be larger than when using a cable, because large amounts of data can be transferred to a screen via cables without image artifacts only with costly shielding measures.

According to an advantageous embodiment, the display unit in the motor vehicle according to the invention also has a rechargeable battery for operating the display unit while detached from the retaining device. This has the advantage that no power cable has to be provided in order to operate the display unit after removal. In this embodiment, a charging unit for charging the accumulator is preferably integrated in the retaining device. This may in particular be based on the principle of induction, thus eliminating the need for exposed electrical contacts. The induction coils may be arranged behind the housing walls.

When using a radio link and a battery, the display unit may be freely positioned in motor vehicle interior. The display unit may even be adapted to set up a data connection via a WLAN router in a data network, e.g. the Internet, outside of the motor vehicle, for example, in an apartment of the user. The display unit may, for example, also be connected to and configured on a home computer of the user or be used for controlling the computer. However, the display unit may also be used independently, for example, as an electronic appointment calendar or as a media player.

According to an advantageous development, the infotainment system in the motor vehicle according to the invention also includes a receiving device different from the display unit for a video data stream, so for example a DVB receiver and/or a receiver for an Internet data stream. Such receiver are known in the prior art. However, in connection with the motor vehicle according to the invention, the controller is now configured to forward a data stream received by the receiver to the display unit. This has the advantage that a user can watch a TV program or browse the Internet on the display unit, regardless whether the display unit is secured in the retaining device or removed from the retaining device.

According to one embodiment, the infotainment system in the motor vehicle according to the invention also has a storage device different from the display unit for storing at least a portion of the display data. For example, video movies or photographs may be stored in the storage device. The controller is then configured to retrieve the stored display data and to transmit them to the display unit. Likewise, a media playback device may be installed in the motor vehicle additionally or alternatively to the storage device, so for example, a Blu-ray player or a DVD player, which can also produce video data that are read by the controller and transmitted to the display unit. Both the storage device and the media playback device therefore do not have to be part of the display unit, but may be installed elsewhere in the motor vehicle. This has the advantage that the actual display unit can be extremely light and especially very shallow.

According to one embodiment of the invention, the display unit includes a security module in which authentication data are stored. The controller is then configured to transmit display data to the display unit only when the display unit is authenticated also at the controller. For this purpose, the controller may send out, for example, a query signal to the display unit, which is then answered by the display unit, based on the authentication data. The controller then verifies the response, for example, by comparing the received authentication data with a list of authentication data for authorized devices. By using a security module, it can advantageously be ensured that the configuration data of the motor vehicle are accessed only by a display unit that is actually authorized for access. This prevents, for example, the display units of two motor vehicles moving next to each other from manipulating the infotainment system of the other motor vehicle.

According to one embodiment, a locating device is provided in the motor vehicle according to the invention, for the purpose of locating the display unit. Thus, the locating device generates locating data indicating where in the motor vehicle the display unit is currently located. This is used in particular to block or cancel the display of certain display data when the display unit is used for example by the driver. This can prevent a driver from being tempted to watch movies while driving. The controller is therefore adapted to transmit at least part of the display data, such as video data, depending on the location data of the locating device. In a particularly simple embodiment, the locating device may have the form of a sensor arranged in the retaining device and which indicates by a sensor signal whether or not the display unit is currently mounted in the retaining device. According to one embodiment, specific data, in particular video data, cannot be displayed when the display unit is mounted in the retaining device. Conversely, when the display unit is detached from the retaining device, it can be assumed that, for example, a passenger or a person in the back seat is using the display unit. Displaying the video data is then safe, so that display data are transferred from the controller to the display unit regardless of their type.

The location of the display unit may also be monitored with a camera, which captures for example the motor vehicle's interior, with the images then being analyzed by an image analyzing device in order to provide location data concerning the display unit. The display unit may also include an infrared light source, such as a light emitting diode, wherein this infrared light source can then be located in an image of an infrared camera, and locating data can then be obtained therefrom for locating the display unit.

According to one embodiment, the invention includes of a retaining device, which also includes a signal unit which is configured to provide an ignition-on signal of the motor vehicle. When the display unit is secured to the retaining device, the display unit can receive this ignition-on signal from the signal unit. The signal transmission can take place galvanically, capacitively or inductively, with the latter two variants again requiring no free electrical contacts. Transmission via NFC technology (NFC—Near Field Communication) is also possible. The signal unit provides the advantage that the display unit can adapt its electric power demand to the operational state of the motor vehicle. When the motor vehicle is switched off, electrical loads such as a WLAN router are normally disabled. Correspondingly, the display unit can then also be deactivated, e.g. switch to a standby mode, since it cannot receive display data from the controller anyway. The signal unit may receive the ignition-on signal for example from a CAN bus (CAN—Controller Area Network). An example of an ignition-on signal is the tap-15 signal.

In a preferred embodiment, the screen of the display unit in the motor vehicle has a protective device for protecting a person in the event of a crash of the motor vehicle, i.e. in a collision of the motor vehicle with another object. For this purpose, a layer of a flexible material is disposed on a transparent viewing window of the screen, i.e. the screen window made for example of transparent plastic or glass. For example, the viewing window may be coated with a polymer. The layer may be provided for example as a foil that is glued or laminated to the viewing window. The layer of flexible material advantageously prevents a person hitting the viewing glass, for example with the face, from receiving cuts caused by splinters of the viewing window in the event of a crash. The flexible layer covers the viewing window and is thus located between the viewing window and the person's skin. If the viewing window splinters, then the flexible material yields and forms a protective skin even when the viewing window is broken. In particular, a layer is selected from a material that is cut-resistant to the extent that an unfavorably disposed splinter cannot cut through the material of the layer when the head of a person cracks the viewing window during a crash.

Advantageously, the viewing window is also designed to have a low reflection. The screen of the display unit has then always excellent visibility independent of its orientation in the motor vehicle, even when, for example, sunlight enters the interior of the motor vehicle through the windows.

The retaining device need not be a single retaining element. Preferably, the retaining device should at least provide a retaining element in the rear of the motor vehicle. However, the retaining device may also provide a retaining element for example in the instrument panel, in the center console, on the headliner, at the rear of the driver's seat and of the passenger seat, respectively.

Likewise, in one embodiment of the motor vehicle, the infotainment system may have a plurality of display units of the aforementioned type. People for example in the rear of the motor vehicle can then have separate display units for using infotainment functions, while the passenger or driver can also access infotainment functions via another display unit.

However, it must be ensured here that infotainment functions required by the driver, for example for driving the motor vehicle, are not slowed down or even blocked, because for example a passenger in the rear seat views a video stream with high resolution, thereby limiting the bandwidth for transmitting the display data to the driver's display unit. For this purpose, according to one embodiment of the invention, the controller of the motor vehicle includes a first computing unit arranged in a front section of the motor vehicle and a second computing unit arranged in a rear section of the motor vehicle. Both computing units are designed to each provide a part of the display data. However, the second computing unit, namely the one in the rear section of the motor vehicle, is designed to transmit its display data to a display unit only when the particular display unit is disposed in a rear section of the motor vehicle. For example, a transmission range of a radio module of the second computing unit may be limited for this purpose accordingly to the rear section of the motor vehicle. For example, beam forming may be used for this purpose.

As stated above, a central feature of the invention is that the display unit of the infotainment system in the motor vehicle according to the invention is detachable. Accordingly, such a separate display unit for an infotainment system according to an embodiment of the motor vehicle according to the invention is also part of the invention. The display unit according to the invention has a mechanical interface that is configured to connect the display unit with the retaining device of the motor vehicle reversible and detachable without being damaged. Thus, for example, an engagement for a snap lock of the retaining device, a rail for engagement in a groove of the retaining device or a groove for engagement of a rail of the retaining device, a magnet or a magnetizable metal plate for one holding magnet of the retaining device may be provided as a mechanical interface. In addition, the display unit of the invention has a separate computing unit, which is designed to cooperate with the controller of the infotainment system of the motor vehicle. Due to this processing unit, the display data received from the controller can then be processed for display of these data on the display screen.

In a preferred, but not specifically claimed embodiment of the display unit, the display unit also includes an operating system. The computing unit is then configured to execute the operating system. This has the advantage that additional dedicated programs or program applications can be installed on the computing unit and that individual infotainment functions of the controller can be more easily accessed by providing corresponding individual program applications.

In another, but not specifically claimed embodiment, the display unit may include one or more cameras for implementing video telephony. The radio module for telephony, for example, a UMTS module or LTE module may then be installed in the motor vehicle, i.e. outside of the display unit. The display unit can then transmit the telephony data to the controller of the motor vehicle, which establishes the actual telephone connection using the telephony module.

The display unit may also include one or more microphones. Especially when several microphones are used, the position of the speaker can advantageously be determined by beamforming, enabling video telephony with a particularly high voice quality.

The invention will now be explained again with reference to specific embodiments, wherein:

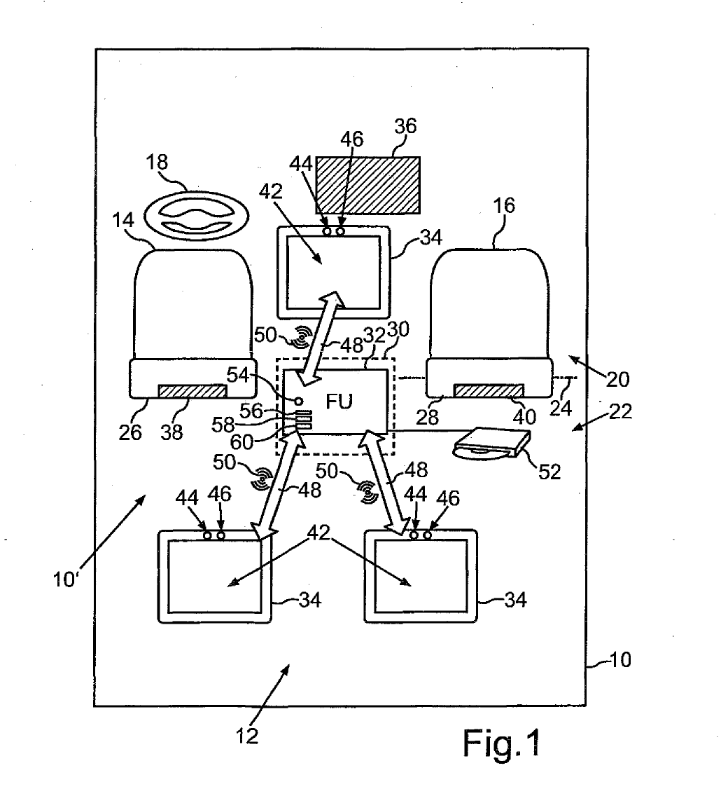

FIG. 1 shows a schematic diagram of a first embodiment of the motor vehicle according to the invention; and

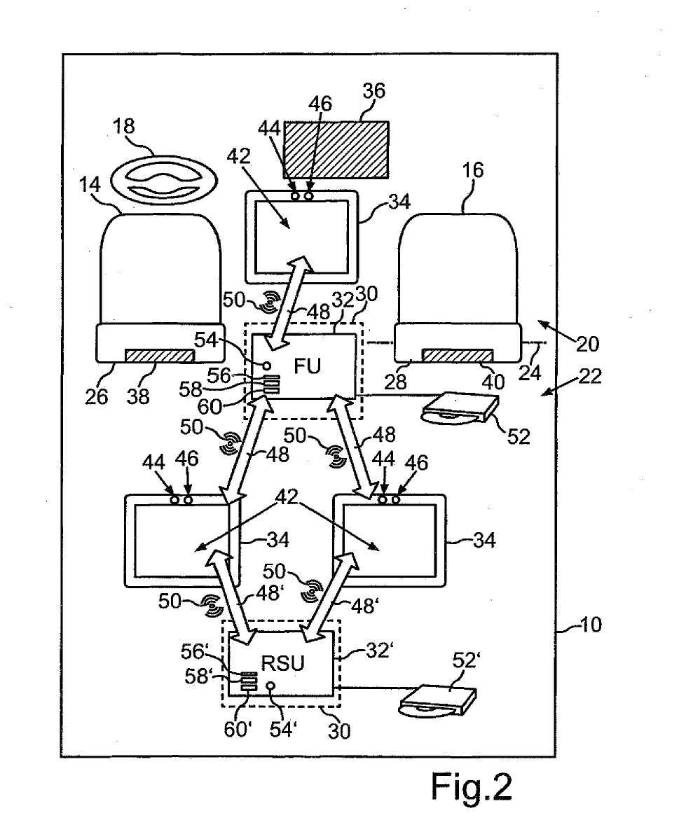

FIG. 2 shows a schematic diagram of a second embodiment of the motor vehicle according to the invention.

The examples represent preferred embodiments of the invention. In the exemplary embodiments described hereinafter, the described components of the embodiments each represent individual features of the invention to be considered independently, which further develop the invention in each case independently of each other and which can thus be regarded as part of the invention individually or in another combination as the combination shown. Furthermore, the described embodiments can also be supplemented by others of the previously described features of the invention.

FIG. 1 shows a motor vehicle 10, which may be for example a passenger car. FIG. 1 shows a motor vehicle interior 10′ in plan view, i.e. a bird's eye view. Shown are an infotainment system 12, a driver seat 14, a front seat 16 and a steering wheel 18. For the further discussion, a front section 20 arranged toward the front of the motor vehicle 10 and a rear section 22 arranged toward the rear of the motor vehicle 10 are distinguished in the motor vehicle by a separation line 24. The location of the separation line 24 may be defined, for example, by a backrest 26 of the driver seat 14 and a backrest 28 of the passenger seat 16. The back seat with an (unillustrated) rear bench can be located in the rear section 22.

The infotainment system 12 includes a controller 30 with a computing unit 32 and, by way of example, three display units 34 to operate the infotainment system 12. The controller 30 may include for example a control device. The display units 34 are removable, meaning they can be detached from the retaining elements 36, 38, 40 in motor vehicle interior 10′ and are, for example, placed on the lap. For this purpose, the display units 34 do not have to be unscrewed or the like, but the retaining devices 36, 38, 40, on the one hand, and the display units 34, on the other hand, each have a magnetic or mechanical interface which is constructed such that the display units 34 can be reversibly detached from their respective retaining device 36, 38, 40 by a user of the motor vehicle 10 during operation thereof without being damaged, in particular in the operation of the infotainment system 12, and continue to be operated. For example, the attachment Interface of the retaining elements 36, 38, 40, on the one hand, and of the display unit 34, on the other hand, may include: a rail system, a locking mechanism, a magnetic holder, a snap closure and/or a mechanism with locking pins, which engage in recesses of the display unit and can be retracted, for example, by pressing a button.

Each display unit 34 has a screen 42, which is preferably part of a touch screen (screen with touch-sensitive surface). Optionally, a display unit 34 may also include a camera 44 and/or a microphone array or a microphone 46. Data may be transmitted between the computing unit 32 and a respective display unit 34 via a radio link 48. For example, the radio link 48 may be provided by WLAN technology 50, which is indicated in FIG. 1 by way of a WLAN icon for the WLAN technology 50. Audio data, video data and other data, in particular image data for displaying a user interface on the screens 42 may be transmitted via the radio link 48. Likewise, operating actions captured on the display units 34, for example, operating the aforementioned touchscreen can be converted by the display units 34 into corresponding control data which can then also be transmitted via the radio link 48 to the computing unit 32.

In the example shown in FIG. 1, the computing unit 32 may be installed in the front section 20, for example, below the center console or in the instrument panel. This is then a so-called Front Unit (FU, front computing unit). The infotainment system 12 may also include a media player 52, for example, a DVD player or Blu-ray player. The data read out by the player data 52 from an optical disc may also be transmitted via the radio links 48 to one or more of the display units 34 and displayed thereon.

The controller 30 may also include other ports, such as an audio port 54, an SDXC port and/or an HDMI port 60. Devices connected via these ports 54, 56, 58, 60 can then also exchange data with the display units 34 via the radio link 48.

The display units 34 constitute intelligent displays (Smart Displays) for displaying image data and for generating control signals that may be exchanged over the wireless data interface, namely, the radio links 48, between the controller 30 in the motor vehicle 10 and the display units 34. Each display unit 34 has a dedicated computing unit, as well as a dedicated battery. A display unit can be connected at different places in the vehicle, namely the retaining devices 36, 38, 40 by way of a suitable retaining device. The retaining devices 36, 38, 40 together form a retaining device. The battery contained in the display unit can also be charged via this retaining device. For this purpose, for example corresponding charging contacts are integrated at the retaining devices 36, 38, 40. At the same time, a secure and fixed storage of the display units 34 in motor vehicle 10 is ensured. The retaining devices can be located in the front section 20 of the vehicle (for example, dashboard, center console front area) or in the rear, i.e. in the rear section 22 (for example, driver/passenger rear seat side, center console rear area). Touch inputs or keystrokes on the display units 34 are transmitted to the controller via a return channel of the wireless connection 48. One or more cameras 44 may be disposed in each display unit 34 for realizing video telephony. Furthermore, one or more microphones 46 (beamforming—determination of the position of the speaker) may be installed in each display unit 34. Each display unit 34 has an operating system, for which purpose, for example, the well-known Android operating system can be used. The operating system can provide access to an Internet web portal by executing corresponding programs, for example an Internet browser, in order to install other applications on the display unit 34.

As shown in FIG. 1, the application of the display units 34 in the rear section 22, especially in the rear seating area, can be used in a simple configuration (Rear Seat Entertainment Basic) together with the same front Unit FU, which also supply display data to the display units 34 arranged in the front section 20.

A greater bandwidth for transmitting the display data is necessary to provide users with additional infotainment features, including simultaneous playback of different high-resolution video image data in the different display units 34. To this end, FIG. 2 shows an embodiment wherein an additional computing unit 32′ is provided in the rear section 22. For a better orientation, the elements which have the same function as corresponding elements in FIG. 1 are given in FIG. 2 the same reference numerals as in FIG. 1.

The additional computing unit 32′ which is configured here as a rear-seat unit (RSU) can transmit additional display data to the display units 34 in the rear section 22 of the motor vehicle 10 via a respective radio link 48′ that is based, for example, also on WLAN technology 50.

Ports 54′, 56′, 58′, 60′ for connecting other devices may also be provided on the rear seat unit, i.e. the computing unit 32′. Also, a media player 52′ may be provided, which can then be used by the display units 34 in the rear section 22.

Overall, the provision of detachable display units 34 enables a more flexible use of the display as well as display of high-resolution image data in both stationary and mobile vehicle use.

Possible realizations for using and controlling of infotainment functions by the invention will now be described. A touch-enabled smart display (Smart Display), which is connected in the vehicle wirelessly (e.g. via WLAN) with a front unit or a rear unit of the infotainment system, allows the customer to operate the entire infotainment system including the comfort settings (for example, air conditioning, seat adjustment).

The following possible adjustment/control choices can be performed in particular with this smart display, i.e. the display units 34:
media control (audio, video selection and control, such as Stop, Play, Pause)
display and control of a built-in or add-on DVD/Blu-ray drive or changer,
playback and control of a built-in radio receiver,
playback and control of a built-in TV, for example, a DVBT tuner,
displaying the current position and/or navigation route (data are transmitted via radio link from the built-in navigation system of the motor vehicle to the appropriate display unit),
entering a new navigation destination on a display unit 34 and transmitting the same to the built-in navigation system of the motor vehicle;
performing video telephony with an integrated camera 44 and microphones 46 in the display unit 34,
displaying games that can be controlled by a controller connected to the display unit, wherein the controller, for example, a joystick or a keyboard, preferably communicates wirelessly with the display unit 34,
displaying the image contents (e.g., video data or games) of a mobile terminal, such as a smartphone or a tablet PC, which communicates via radio with the display unit 34 directly or indirectly via the controller 30,
adjusting the climate control settings of the display unit 34,
adjusting the seat settings with the display unit 34,
adjusting the seat massage functions,
adjusting the lighting control,
access to a telephone/address database of the infotainment system, which may be stored in the controller 30,
character input for navigation, phone book, media search, in particular by way of handwriting recognition, and forwarding the recognized characters or the detected handwriting to the controller 30,
character input via on-screen keyboard when the screen 42 is a touch screen, and forwarding the characters to the controller 30,
control with an orientation sensor, which may be installed in the display unit 34,
control by voice control, wherein a recording may be performed with built-in microphones 46 and the recognized commands or extracted speech features (e.g., cepstral coefficients) or the actual audio signal may then be forwarded to the controller 30.

Overall, instead of a permanently installed display, which can be read at only one location in the motor vehicle and, in the case of a touch-enabled display, operated only at the permanently installed location, the invention provides a display unit that can be freely positioned in the motor vehicle. This display unit is designed as a user interface for an infotainment system of the motor vehicle and configured to display via the radio link on a screen also larger data volumes, such as high-resolution video data, without problems.

1-15. (canceled)

16. A motor vehicle comprising an infotainment system for providing infotainment functions, the infotainment system comprising:
a controller, and
a display unit that is structurally separate from the controller and functions as a user interface and has a rechargeable battery and a screen for displaying display data,
the motor vehicle further comprising
a retaining device disposed in an interior of the motor vehicle and configured to mechanically retain the display unit so that the retaining device and the display unit are non-destructively and reversibly detachable from one another, the retaining device comprising an integrated charging device for charging the rechargeable battery and a signal unit which is configured to receive and provide an ignition-on signal of the motor vehicle from a CAN (Controller Area Network) bus,
wherein the controller is configured to transmit the display data to the display unit even when the display unit is detached from the retaining device.

17. The motor vehicle of claim 16, wherein at least one operating element of the user interface is integrated in the display unit and wherein the display unit is configured to send control data to the controller in response to actuation of the at least one operating element.

18. The motor vehicle of claim 16, wherein the screen is a touch screen.

19. The motor vehicle of claim 16, wherein the controller and the display unit each have a radio module and are configured to exchange data with each other via a radio link set up between the radio modules.

20. The motor vehicle of claim 19, wherein the radio link between the radio modules is at least one of a WLAN connection and a Bluetooth connection.

21. The motor vehicle of claim 16, wherein the infotainment system comprises a receiver that is separate from the display unit for a video data stream or an Internet data stream, or both, and wherein the controller is configured to forward a data stream received from the receiver to the display unit.

22. The motor vehicle of claim 16, wherein the infotainment system comprises a storage device separate from the display unit for storing at least a portion of the display data or a media playback device for playing back at least a portion of the display data, or both, and wherein the controller is configured to retrieve the portion of the display data and to transmit the portion of the display data to the display unit.

23. The motor vehicle of claim 16, wherein the display unit comprises a security module storing authentication data, and wherein the controller is configured to transmit the display data to the display unit only when the display unit is authenticated with the controller.

24. The motor vehicle of claim 16, further comprising a locating device designed to locate the display unit, and wherein the controller is configured to transmit at least a portion of the display data in dependence of position data of the locating device.

25. The motor vehicle of claim 16, wherein a layer made of a flexible material is arranged on a transparent viewing window of the screen of the display unit.

26. The motor vehicle of claim 16, wherein at least one retaining device is disposed in a rear section of the motor vehicle.

27. The motor vehicle of claim 16, wherein the controller comprises a first computing unit arranged in a front section of the motor vehicle and a second computing unit arranged in a rear section of the motor vehicle, wherein the first and the second computing units are configured to each provide a respective portion of the display data, and wherein the second computing unit is configured to transmit its display data to the display unit only when the display unit is located in the rear section of the motor vehicle.

28. The motor vehicle of claim 16, wherein the infotainment system comprises a plurality of the display units.

29. A display unit for an infotainment system of a motor vehicle, comprising:
a mechanical interface, which is designed to connect the display unit mechanically or magnetically, or both, reversibly detachably and nondestructively with a retaining device of the motor vehicle,
a dedicated computing unit, which is configured to cooperate with a controller of the infotainment system of the motor vehicle, and
a rechargeable battery for enabling operation of the display unit when the display unit is detached from the retaining device,
wherein the display unit is configured to receive an ignition-on signal from a signal unit of the retaining device, when the display unit is attached to the retaining device, and wherein the display unit is configured to adapt its electric power demand to an operating state of the motor vehicle by automatically deactivating the display unit when the motor vehicle is shut off.
